(19) United States
(12) Patent Application Publication
(10) Pub. No.: US 2026/0342426 A1
(43) Pub. Date: Oct. 29, 2026

(54) TECHNIQUES FOR RELIABLE MOBILITY

(71) Applicant: InterDigital Patent Holdings, Inc., Wilmington, DE (US)

(72) Inventors: Paul Marinier, Brossard (CA); Brian Martin, Farnham (GB); Keiichi Kubota, Setagaya-Ku (JP); Oumer Teyeb, Montreal (CA); Martino Freda, Laval (CA)

(73) Assignee: InterDigital Patent Holdings, Inc., Wilmington, DE (US)

(21) Appl. No.: 18/997,358

(22) PCT Filed: Aug. 3, 2023
(86) PCT No.: PCT/US2023/071565

§ 371 Date: Jan. 21, 2025

Related U.S. Application Data
(60) Provisional application No. 63/395,066, filed on Aug. 4, 2022.

(51) Int. Cl. H04B 7/06; H04L 5/00; H04W 56/00; H04W 72/231; H04W 76/20; H04W 80/02

(52) U.S. Cl. CPC H04B 7/06968; H04L 5/0051; H04W 56/0015; H04W 72/231; H04W 76/20; H04W 80/02

(57) ABSTRACT

A WTRU may receive configuration information for transitioning from a source cell to a target cell comprising at least one parameter. The WTRU may transmit an indication of one or more measurements associated with the source and target cell, and may receive signaling associated with the transition comprising at least one value for the at least parameter associated with the transitioning. The WTRU may transition to the target cell using the at least one value for the at least one parameter associated with the transitioning. Configuration information may be received via RRC signaling. The indication of one or more measurements may be transmitted via L1 and/or L2 signaling and may be via a CSI report. At least one parameter may comprise a RACH preamble, timing advance, C-RNTI, initial grant for the target cell, and or beam indication. The signaling may be received via a MAC CE and/or DCI signaling.

### CROSS REFERENCE TO RELATED APPLICATIONS

This application claims the benefit of U.S. Provisional Patent Application No. 63/395,066, filed Aug. 4, 2022, which is hereby incorporated herein by reference in its entirety.

### BACKGROUND

A source next generation node B (gNB) may configure a wireless transmit/receive unit (WTRU) with certain measurement procedures, and the WTRU may send reports according to the measurement configuration. The source gNB may determine to handover the WTRU, based on the received measurements. The source gNB may transmit a handover request message to a target gNB, passing a transparent radio resource control (RRC) container that includes the information to prepare the handover at the target side. Admission control may be performed by the target gNB. If the WTRU is able to be admitted, the target gNB may prepare the handover (e.g., with physical layer-1 (L1)/datalink layer-2 (L2)) and transmit a handover request acknowledge message to the source gNB, which may, for example, include a transparent RRC container (e.g., to be sent to the WTRU as an RRC message to perform the handover). The source gNB may trigger a user to user (Uu) handover, for example, by transmitting an RRCReconfiguration message to the WTRU. For example, the RRCReconfiguration message may include certain information for accessing the target cell, such as: the target cell identifier (ID), the new cell radio network temporary identifier (C-RNTI), and/or the target gNB security algorithm identifiers for the selected security algorithms. Also, or alternatively, the RRCReconfiguration message may include: a set of dedicated random access channel (RACH) resources, the association between RACH resources and synchronization signal block(s) (SSB(s), the association between RACH resources and WTRU-specific channel state information reference signal (CSI-RS) configuration(s), common RACH resources, system information (SI) of the target cell, etc.

### SUMMARY

A wireless transmit receive unit (WTRU) may receive, from a network node, configuration information that comprises a conditional handover (CHO) configuration. The terms user equipment (UE) and WTRU are used interchangeably herein. For example, the CHO configuration may be associated with a trigger and a target cell. The CHO may comprise an indication of one or more of the following: an identity of the target cell; an identity of the source configuration; and/or an identity of an additional configuration. The trigger may include a handover (HO) command and/or a measurement event. The WTRU may determine that the trigger associated with the CHO configurations is met. For example, if the trigger is an HO command, the WTRU may determine that the trigger is met when the WTRU received the HO command (e.g., form the target cell). In response to determine that the trigger has been met, the WTRU may initiate a CHO with the target cell. For example, the CHO may be initiated via a random access channel (RACH) procedure. Also, or alternatively, the CHO may be initiated via a RACH-less procedure.

An example method for reliable mobility may be performed by a WTRU. The method may comprise receiving configuration information for transitioning from a source cell to at least one target cell. The configuration information may comprise at least one parameter associated with the transitioning. The WTRU may transmit an indication of one or more measurements associated with the source cell and a first target of the at least one target cell. The WTRU may receive signaling comprising information associated with the transition to the first target cell. The signaling may comprise at least one value for the at least one parameter associated with the transitioning. The WTRU may transition to the first target cell using the at least one value for the at least one parameter associated with the transitioning. The configuration information may be received via radio resource control (RRC) signaling. The indication of the one or more measurements associated with the source cell and the first target cell may be transmitted via layer 1 (L1) signaling, layer 2 (L2) signaling, or a combination thereof. The at least one parameter may comprise at least one of a random access channel (RACH) preamble, a timing advance, a cell radio network temporary identifier (C-RNTI), an initial grant for the first target cell, a beam indication, or a combination thereof. The signaling comprising information associated with the transition to the first target cell may be received via a medium access control (MAC) control element (CE). The signaling comprising information associated with the transition to the first target cell may be received via downlink control information (DCI) signaling. The indication of the one or more measurements associated with the source cell and the first target cell may be transmitted via a channel state information (CSI) report.

An example WTRU configured for reliable mobility may comprise a transceiver and a processor. The processor may be configured to receive, via the transceiver, configuration information for transitioning from a source cell to at least one target cell. The configuration information may comprise at least one parameter associated with the transitioning. The processor may be configured to transmit, via the transceiver, an indication of one or more measurements associated with the source cell and a first target cell of the at least one target cell. The processor may be configured to receive, via the transceiver, signaling comprising information associated with the transition to the first target cell. The signaling may comprise at least one value for the at least one parameter associated with the transitioning. The processor may be configured to transition to the first target cell using the at least one value for the at least one parameter associated with the transitioning. The configuration information may be received via radio resource control (RRC) signaling. The indication of the one or more measurements associated with the source cell and the first target cell may be transmitted via layer 1 (L1) signaling, layer 2 (L2) signaling, or a combination thereof. The at least one parameter may comprise at least one of a random access channel (RACH) preamble, a timing advance, a cell radio network temporary identifier (C-RNTI), an initial grant for the first target cell, a beam indication, or a combination thereof. The signaling comprising information associated with the transition to the first target cell may be received via a medium access control (MAC) control element (CE). The signaling comprising information associated with the transition to the first target cell may be received via downlink control information (DCI) signaling. The indication of the one or more measurements associated with the source cell and the first target cell may be transmitted via a channel state information (CSI) report.

An example network node for effectuating reliable mobility may comprise a transceiver and a processor. The processor may be configured to send, via the transceiver, configuration information for transitioning from a source cell to at least one target cell. The configuration information may comprise at least one parameter associated with the transitioning. The processor may be configured to receive, via the transceiver, an indication of one or more measurements associated with the source cell and a first target cell of the at least one target cell. The processor may be configured to send, via the transceiver, signaling comprising information associated with the transition to the first target cell. The signaling may comprise at least one value for the at least one parameter associated with the transitioning. The configuration information may be sent via radio resource control (RRC) signaling. The indication of the one or more measurements associated with the source cell and the first target cell may be received via layer 1 (L1) signaling, layer 2 (L2) signaling, or a combination thereof. The at least one parameter may comprise at least one of a random access channel (RACH) preamble, a timing advance, a cell radio network temporary identifier (C-RNTI), an initial grant for the first target cell, a beam indication, or a combination thereof. The signaling comprising information associated with the transition to the first target cell may be sent via a medium access control (MAC) control element (CE). The signaling comprising information associated with the transition to the first target cell may be sent via downlink control information (DCI) signaling. The indication of the one or more measurements associated with the source cell and the first target cell may be received via a channel state information (CSI) report.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example handover;

FIG. 3 illustrates an example conditional handover (CHO);

FIG. 4 illustrates example layer 1/layer 2 (L1/L2) inter-cell mobility;

FIG. 5 illustrates example transition configurations; and/or

FIG. 6 illustrates example updating/changing a WTRU's primary cell (PCell).

### DETAILED DESCRIPTION

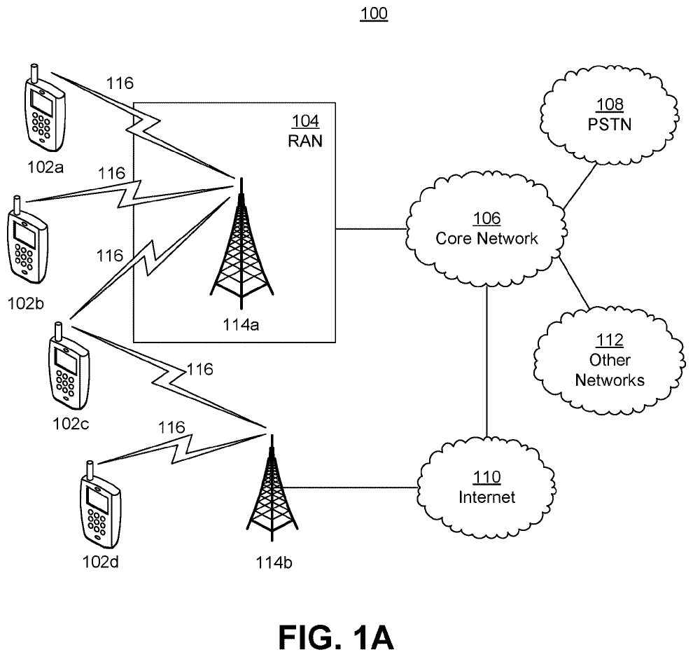

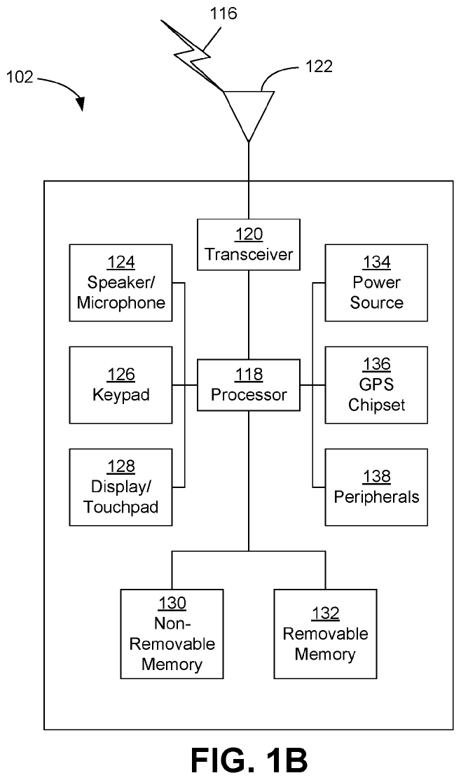

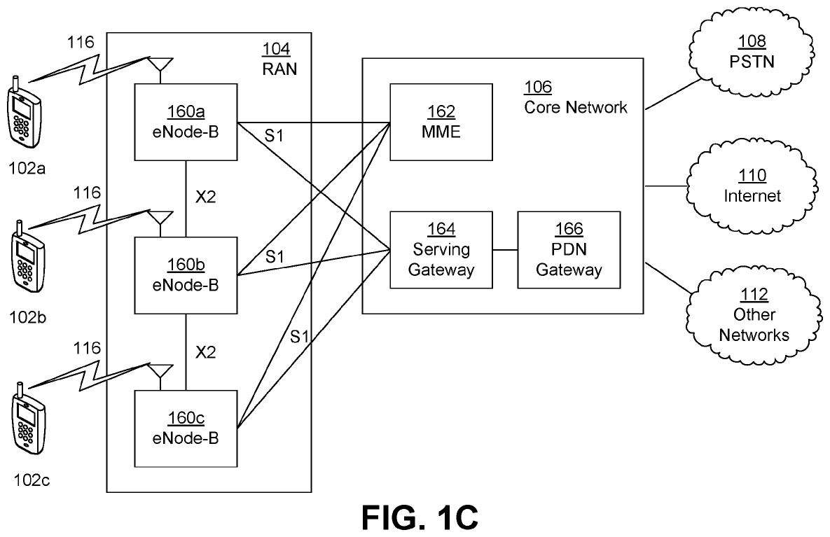

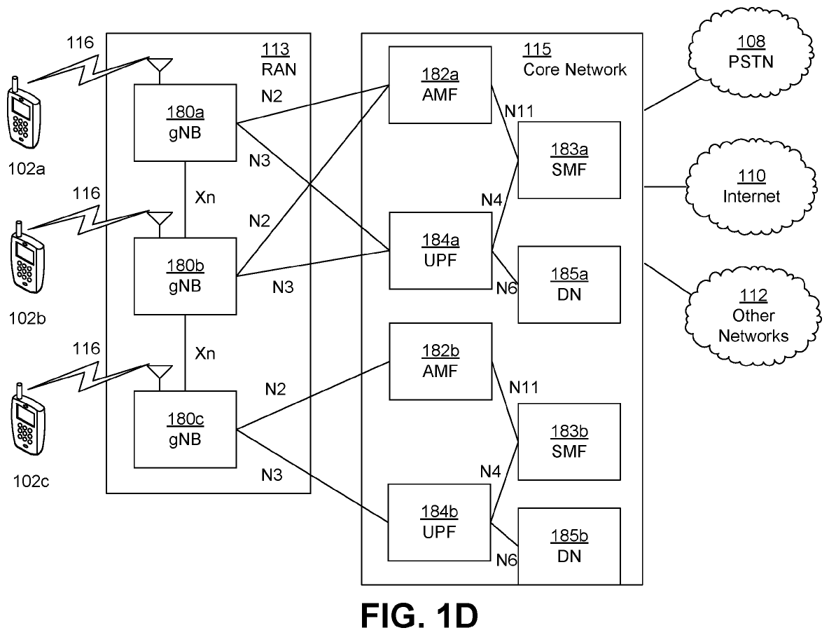

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUS 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160cmay implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180cusing signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160cmay serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QOS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, a network node may comprise any appropriate network entity, such as, for example, a base station, a base transceiver station (BTS), a Node-B, an eNode B, a Home Node B, a Home eNode B, a gNB, a NR NodeB, a site controller, an access point (AP), a wireless router, a relay node, an access control and mobility management function (AMF), a source node, a target node, or the like, or any appropriate combination thereof.

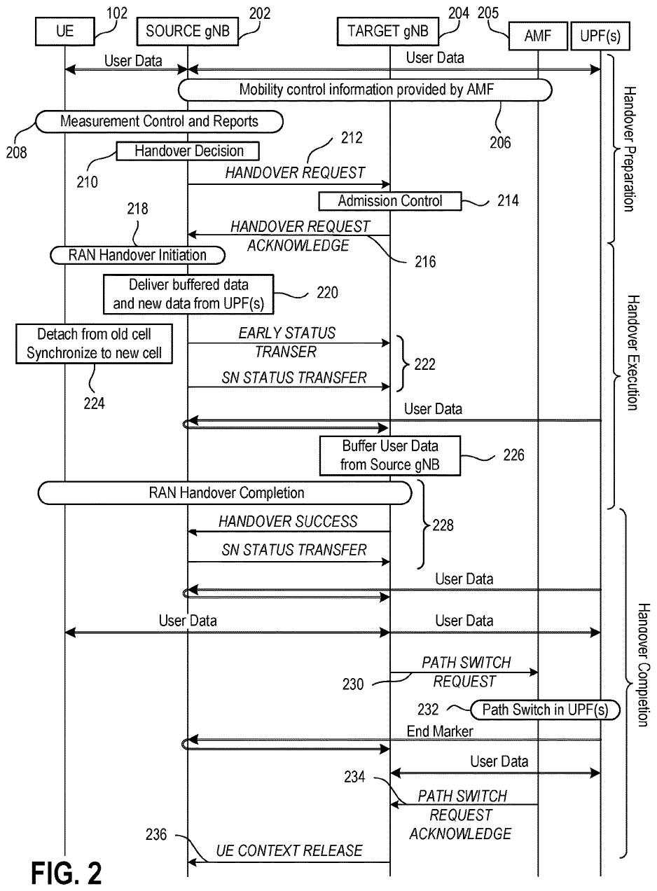

FIG. 2 illustrates an example handover process in a network (e.g., NR.). One or more of the following may apply. WTRU (e.g. WTRU 102) context within a source gNB (e.g., gNB 202) may contain information regarding roaming and access restrictions which may have been provided either at connection establishment or at an RA (Registration Area) update at step 206. Source gNB 202 may configure WTRU 102 (depicted as UE in FIG. 2) with certain measurement procedures, and WTRU 102 may send reports according to the measurement configuration at step 208. Source gNB 202 may determine to handover WTRU 102 based on the received measurements at step 210. At step 212, source gNB 202 may transmit a handover request message to a target gNB 204, passing, for example, a transparent RRC container that may include information to prepare the handover at the target side. For example, the information may include one or more of the following: a target cell ID, a generated 5G NR key (KgNB), the C-RNTI of the WTRU in the source gNB, radio resource management (RRM)-configuration including WTRU inactive time, basic access stratum (AS)-configuration including antenna information and downlink (DL) carrier frequency, the current quality of service (QOS) flow to data radio bearer (DRB) mapping rules applied to the WTRU, the system information B1 (SIB1) from source gNB, the WTRU capabilities for different radio access technologies (RATs), protocol data unit (PDU) session related information, and/or WTRU reported measurement information (e.g., including beam-related information if available). Admission control may be performed by target gNB 204 at step 214. If WTRU 012 is able to be admitted, target gNB 204 may prepare the handover (e.g., with L1/L2) and transmit a handover request acknowledge message to source gNB 202 at step 216. The handover request acknowledge message may include, for example, a transparent RRC container (e.g., to be sent to WTRU 102 as an RRC message to perform the handover). At step 218, source gNB 202 may trigger a Uu handover, for example, by transmitting an RRCReconfiguration message to WTRU 102. For example, the RRCReconfiguration message may include certain information for accessing the target cell, such as: the target cell ID, the new C-RNTI, and/or the target gNB security algorithm identifiers for the selected security algorithms. Also, or alternatively, the RRCReconfiguration message may include: a set of dedicated RACH resources, the association between RACH resources and SSB(s), the association between RACH resources and WTRU-specific CSI-RS configuration(s), common RACH resources, system information (SI) of the target cell, etc.

As shown in FIG. 2, a source network node, such as source gNB 202 may transmit a secondary node (SN) status transfer message to a target network node, such as target gNB 204. For example, the SN status transfer message may include an indication of the uplink packet data convergence protocol (PDCP) SN receiver status and/or the downlink PDCP SN transmitter status of DRBs for which PDCP status preservation applies (e.g., for radio link control (RLC) acknowledgement mode (AM)). At step 220, the source gNB may deliver buffered data and new data from UPF(s) to the WTRU. At step 224, WTRU 102 may synchronize with the target cell and complete the RRC handover procedure at step 228, for example, by sending an RRCReconfigurationComplete message to target gNB 204. At step 226, the target gNB may buffer user data received from the source gNB. At step 230, target gNB 204 may transmit a path switch request message to a network node, such as access control and mobility management function (AMF), 205, for example, to trigger the network (e.g., 5G core network (5GC)) to switch the DL data path towards target gNB 204 and/or to establish an new generation-core (NG-C) interface instance towards target gNB 204. The 5GC may switch the DL data path towards target gNB 204. The user plane function (UPF) may transmit one or more end marker packets on the old path to source gNB 202 (e.g., on a per protocol data unit (PDU) session/tunnel basis) at step 232. A UPF may release any U-plane/TNL (transport network layer) resources towards source gNB 202. AMF 205 may confirm the path switch request message with a path switch request acknowledge message at step 234. At step 236, upon reception of the PATH SWITCH REQUEST ACKNOWLEDGE message from AMF 205, target gNB 204 may send the WTRU CONTEXT RELEASE to inform source gNB 202 about the success of the handover. Source gNB 202 may then release radio and C-plane related resources associated with the WTRU context. Any ongoing data forwarding may continue.

Certain networks (e.g., NR) may perform conditional handover (CHO) and Conditional primary secondary serving cell (PSCell) Change (CPC). One or more of the following may apply. Certain networks may have implemented CHO and/or CPC/conditional PSCell Addition (CPA), which may be used to reduce the likelihood of radio link failures (RLF) and/or handover failures (HOF). Collectively, CHO and CPA/CPA may be referred to as CPAC.

In certain networks (e.g., legacy LTE/NR) handover may be triggered by measurement reports. However, the network may not be prevented from sending a HO command to the WTRU (e.g., even without receiving a measurement report). For example, a WTRU may be configured with an A3 event that triggers a measurement report to be sent when the radio signal level/quality (e.g., reference signal received power (RSRP), reference signal received quality (RSRQ), etc.) of a neighbor cell becomes better than the radio signal level/quality of a primary serving cell (PCell) or a primary secondary serving cell (PSCell) (e.g., in the case of dual connectivity (DC)). The WTRU may monitor serving and neighbor cells, and may send a measurement report when the conditions get fulfilled (e.g., when the radio signal level/quality of a neighbor cell becomes better than the radio signal level/quality of the PCell and/or the PSCell). When such a report is received, the network (e.g., current serving node/cell) may prepare and transmit a HO command (e.g., an RRC ReConfiguration message that includes a reconfigurationWithSync) to the WTRU. In response to receiving the HO command, the WTRU may (e.g., immediately) execute the HO and connect to the target cell.

CHO, however, may differ from the scenario described above. One or more of the following may apply. In networks that implement CHO, multiple handover targets may be prepared (e.g., as compared to only one target in other implementations). In networks that implement CHO, the WTRU may not execute (e.g. immediately execute) the CHO. Instead, the WTRU may be configured with triggering conditions (e.g., a set of radio conditions), and the WTRU may execute the handover towards one of the targets when/if a triggering condition is fulfilled.

A CHO command may be sent when, for example, the radio conditions towards the current serving cells are still favorable, which may reduce the (e.g., two) main points of failure. For example, the main points of failure may include failing to send the measurement report (e.g. if the link quality to the current serving cell falls below acceptable levels when the measurement reports are triggered in normal handover), and/or failing to receive the handover command (e.g. if the link quality to the current serving cell falls below acceptable levels after the WTRU has sent the measurement report, but before it has received the HO command).

The triggering conditions for a CHO may also, or alternatively, be based on the radio quality of the serving cells and neighbor cells (e.g., like the conditions that are used in legacy NR/LTE to trigger measurement reports). For example, the WTRU may be configured with a CHO that is associated with A3 like triggering conditions and associated HO command. The WTRU may monitor the current and serving cells and, when the A3 triggering conditions are fulfilled, the WTRU may execute the associated HO command and switch its connection towards the target cell (e.g., instead of sending a measurement report).

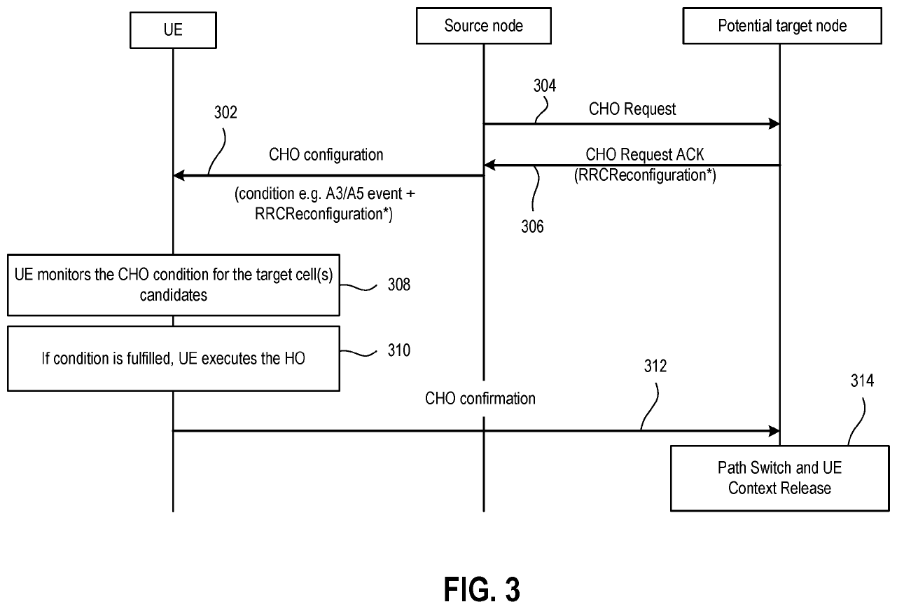

FIG. 3 illustrates an example CHO configuration and execution. At step 304, the source node (e.g., gNB)may send a CHO Request (e.g., a Handover Request message) to one or more target nodes (e.g., gNBs). At step 306, the target node may send a CHO Request ACK (e.g., in a Handover Request ACK, containing a transparent container containing RRCReconfiguration). At step 302, the source gNB may transmit the CHO configuration to the WTRU (e.g., transmits an RRCReconfiguration to the WTRU, providing a target gNB configuration to apply upon performing the CHO, and a condition to be satisfied, for example measurement event A3/A5). At step 308, the WTRU may monitor the CHO condition for the target cell(s) (e.g., performs radio quality measurements and evaluates the configured events). At step 310, if the condition is fulfilled then the WTRU may execute the HO (e.g., applies the target gNB configuration once the event criteria is satisfied). At step 312 the WTRU may transmit a CHO configuration (e.g., RRCReconfigurationComplete) to the target node. At step 314, the target node may detect handover completion (e.g., based on the reception of the RRCReconfigurationComplete message), performs NGAP Path Switch procedure and triggers the release of the WTRU context in the source gNB.

CHO may be used to prevent unnecessary re-establishment (e.g., in case of a radio link failure). As described herein, a WTRU may be configured with one or more CHO targets. If the WTRU experiences a RLF before a triggering condition for any of the targets is fulfilled, the WTRU may execute an HO command associated with a target cell with (e.g., a target cell that is already prepared for it) directly, for example, instead of continuing with the full re-establishment procedure. In other networks (e.g., legacy LTE/NR), however, a RRC re-establishment procedure may be initiated, which may incur interruption time for the bearers of the WTRU.

CPC and CPA may be considered extensions of CHO in dual connectivity (DC) scenarios. A WTRU may be configured with triggering conditions for PSCell change or addition, and when the triggering conditions are fulfilled, the WTRU may execute the associated PSCell change or PSCell add commands.

Inter-cell beam management and/or inter-cell L1/2 mobility may be performed. One or more of the following may apply. In certain networks (e.g., NR R17) inter-cell L1/2 mobility may be used for beam management (e.g., in carrier aggregation (CA). Cell change/addition, however, may not be supported.

In certain networks (e.g., NR R18), it may be useful to specify the mechanisms and procedures of L1/L2 based inter-cell mobility for mobility latency reduction. One or more of the following may apply. Configuration and maintenance for multiple candidate cells may be specified to allow fast application of configurations for candidate cells (e.g., RAN2, RAN3). Dynamic switching mechanisms (e.g., among candidate serving cells, including SpCell and SCell) may be specified and/or may be applicable to certain scenarios based on L1/L2 signaling (e.g., RAN2, RAN1). L1 enhancements for inter-cell beam management, including L1 measurement and reporting, and beam indication (e.g., RAN1, RAN2) may be specified. For example, RAN2 may be involved, for example, to further clarify the interaction between L1 enhancements for inter-cell beam management and dynamic switching mechanisms among candidate serving cells. Timing advance management (e.g., RAN1, RAN2) may be specified. Centralized Unit-Data Unit (CU-DU) interface signaling may be specified to support L1/L2 mobility (e.g., if necessary, RAN3). For example, frequency range 2 (FR2) specific enhancements may not be precluded. Also, or alternatively, procedures for L1/L2 based inter-cell mobility may be defined for one or more of the following scenarios: the standalone scenario; CA and NR-DC scenarios (e.g., with serving cell changes within a cell group (CG); the intra-DU and intra-centralized unit (CU) inter-distributed unit (DU) scenarios (e.g., which may be applicable for standalone and CA); intra-frequency and inter-frequency scenarios; frequency range 1 (FR1) and FR2 scenarios; and/or scenarios where the source and target cells that are either synchronized or non-synchronized. Inter-CU scenarios may not be included.

L1/L2 based mobility may be supported in certain networks (e.g., 5G R17). For example, inter-cell beam management (e.g., in R17) may address intra-DU and intra-frequency scenarios. In this case the serving cell may remain unchanged (e.g., if there is no possibility to change the serving cell using L1/2 based mobility). In FR2 deployments, CA may be used to exploit the available bandwidth, e.g., to aggregate one or more (e.g., multiple) component carriers (CCs) in a (e.g., one) band. These CCs may be transmitted with an analog beam pair (e.g., the same analog beam pair, such as a gNB beam and a WTRU beam). The WTRU may be configured with one or more (e.g., 64) transmission configuration indicators (TCI) states for reception of physical downlink control channel (PDCCH) and physical downlink shared channel (PDSCH). Each TCI state may include/be associated with a reference signal (RS) or synchronization signal and physical broadcast control channel block (SSB) that the WTRU may refer to, for example, for setting its beam. The SSB may be associated with a non-serving physical cell ID (PCI). Medium access control (MAC) signaling (e.g., a TCI state indication for WTRU-specific PDCCH MAC control element (CE)) may be used to activate the TCI state for a given coreset/PDCCH. Reception of a PDCCH transmission from a non-serving cell may be supported by a MAC CE indicating a TCI state associated to non-serving PCI. MAC signaling (e.g., a “TCI States Activation/Deactivation for WTRU-specific PDSCH”) may be used to activate a subset of (e.g., up to 8) of TCI states for PDSCH reception. Downlink control information (DCI) may be used to indicate the subset of TCI states for PDSCH reception. A “unified TCI state” associated with a different updating mechanism (e.g., DCI-based) may be supported. Multi-TRP techniques (e.g., unified TCI state with multi-TRP) may be supported in certain networks (e.g., 5G R18).

L1/2 inter-cell mobility may be used to improve handover latency (e.g., as compared to conventional L3 handover or CHO). One or more of the following may apply. A WTRU may send (e.g., may first send) a measurement report (e.g., using RRC signaling). In response to a measurement report, the network may provide a further measurement configuration and/or a CHO configuration. In other scenarios however, the network may provide a configuration that indicates a target cell (e.g., after the WTRU reports, using RRC signaling, that the cell meets a configured radio quality criteria). In such a scenario, the WTRU may delay sending the measurement report (e.g., in order to reduce the handover failure rate) until the WTRU receives an RRC reconfiguration from the network that indicates a target cell configuration and/or a measurement criteria, which may be used to determine when the WTRU should trigger the CHO configuration. In either of the above scenarios, however, some amount of delay (e.g., due to the sending of measurement reports and receiving of target configurations, for example, in case of the conventional (non-conditional) handover) may be present.

L1/2 based inter-cell mobility may be used to allow a fast application of configurations for candidate cells including, for example, dynamically switching between secondary cells (SCells) and the primary cell (PCell) (e.g. switch the roles between SCell and PCell) without performing RRC signaling. In some networks (e.g., 5G R18), an inter-CU scenario may not be supported, for example, as a PDCP anchor may be (e.g., may need to be) relocated. An RRC based approach support inter-CU handover may be provided. Also, or alternatively, L1/L2 may be used to allow CA operation to be enabled (e.g., enabled instantaneously upon a serving cell change).

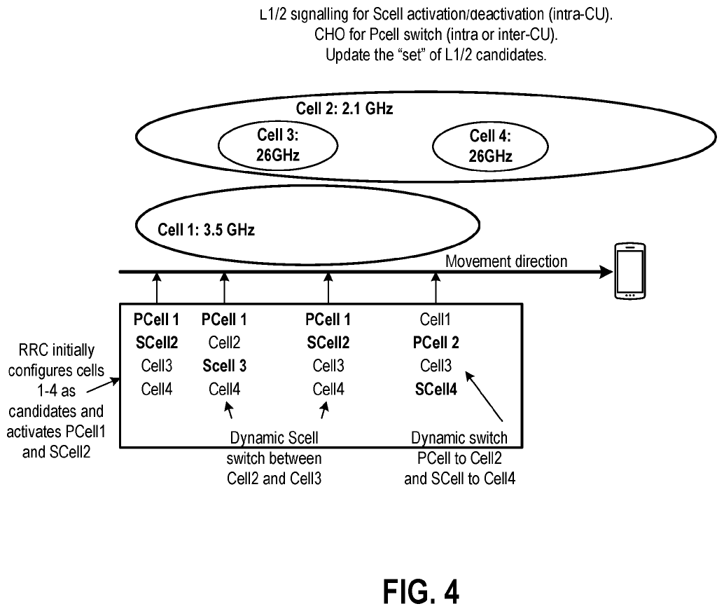

FIG. 4 illustrates example L1/2 inter-cell mobility operation using CA. As shown in FIG. 4, a candidate cell group may be configured by RRC and a dynamic switch between the PCell and SCell may be achieved using L1/2 signaling.

RACH-less handover may be performed. One or more of the following may apply. RACH-less handover may be used (e.g., used by E-UTRA systems in R14) to reduce the mobility interruption time. The target eNB may indicate the uplink timing to be used for the target cell in the handover command. The target eNB may also, or alternatively, provide a pre-allocated uplink grant for the transmission of a handover complete message.

Radio link monitoring may be performed. One or more of the following may apply. A WTRU may perform radio link monitoring (RLM) at an SpCell, for example, to maintain the radio link. Certain techniques may be used to indicate an out-of-sync (e.g., physical layer problem) and/or in-sync errors associated with the radio link. Certain techniques may be used to declare a radio link failure (RLF) and/or to recover the physical layer problems. A WTRU may monitor the downlink radio link quality, for example, based on a reference signal configured as RLM-RS resource(s), to determine the downlink radio link quality of the PCell and PSCell. The configured RLM-RS resources may include one or more SSBs, one or more CSI-RSs, and/or a mix of SSBs and CSI-RSs. For example, the WTRU may not be required to perform RLM outside the active DL BWP.

A WTRU may evaluate whether the downlink radio link quality on a configured RLM-RS resource estimated over the evaluation time (e.g., TEvaluate_out_SSB ms) period is less than a threshold (e.g., Qout_SSB). The WTRU may also, or alternatively, evaluate whether the downlink radio link quality on the configured RLM-RS resource estimated over another evaluation time (e.g., within TEvaluate_in_SSB [ms]) is greater than another threshold (e.g., Qin_SSB).

A WTRU may detect an of out-of-sync error associated with the radio link. One or more of the following may apply. The WTRU may, upon receiving a number (e.g., N310) of consecutive “out-of-sync” indications for an SpCell (e.g., from lower layers while the T300, T301, T304, T311 and T319 timers are not running), start a timer (e.g., T310) for the corresponding SpCell.

A WTRU may recover from certain physical layer problems. One or more of the following may apply. The WTRU may, upon receiving a number (e.g., N310) of consecutive “out-of-sync” indications for an SpCell (e.g., from lower layers while the T310 timer is running), stop the timer (e.g., T310) for the corresponding SpCell. The WTRU may maintain the RRC connection, for example, without explicit signaling (e.g., the WTRU maintains the entire radio resource configuration). For example, the periods in time where neither “in-sync” nor “out-of-sync” is reported by L1 may not affect the evaluation of the number of consecutive “in-sync” or “out-of-sync” indications.

A WTRU may declare an RLF upon expiry of the timer (e.g., T310).

If a WTRU changes its PCell while the WTRU is in the connected mode, the WTRU may determine (e.g., may need to determine) a timing advance for uplink transmission in the updated PCell (e.g., the target PCell) and receive a PDCCH transmission (e.g., with an increased reliability). However, such a procedure has not yet been provided when a change in PCell is performed as part of L1/2 mobility.

Described herein are techniques associated with changing PCells as part of L1/L2 mobility. One or more of the following may apply. A WTRU may determine the best quality cell(s), e.g., based on the neighboring cell measurements and/or the serving cell measurements. The WTRU may report the best quality cell(s), for example, via uplink signaling (e.g. an uplink MAC CE), which may be used to indicate the candidate target cells' information (e.g., PCI, CGI and/or frequency of the cell(s).

A WTRU may synchronize to/with the target cell(s) and may start monitoring the PDCCH of the reported candidate target cell(s). The WTRU may wait for a PDCCH order associated with an HO command (e.g., or MAC CE indicating HO command) from a gNB.

A WTRU may receive a PDCCH order associated with an HO command from the candidate target cell. The PDCCH order associated with the HO command may be used to command the WTRU to perform an HO from the current serving cell (e.g., SpCell) to another cell. For example, the WTRU may receive the PDCCH order associated with the HO command. Also, or alternatively, the WTRU may receive a MAC CE associated with the HO command from the current serving cell. The MAC CE associated with the HO command may indicate the target cell information, where the WTRU may perform HO from the current serving cell to the given target cell.

A WTRU may receive configuration information that comprises a conditional handover (CHO) configuration. For example, the CHO configuration may be associated with a trigger and a target cell. The CHO may comprise an indication of one or more of the following: an identity of the target cell; an identity of the source configuration; and/or an identity of an additional configuration. The trigger may include a handover (HO) command and/or a measurement event. The WTRU may determine that the trigger associated with the CHO configurations is met. For example, if the trigger is an HO command, the WTRU may determine that the trigger is met when the WTRU received the HO command (e.g., from the target cell). In response to determine that the trigger has been met, the WTRU may initiate a CHO with the target cell. For example, the CHO may be initiated via a random access channel (RACH) procedure. Also, or alternatively, the CHO may be initiated via a RACH-less procedure.

A framework associated with L1/L2 mobility may be provided. For example, a WTRU may be configured with CHO and/or mobility triggers. One or more of the following may apply. A WTRU may receive and optionally store a set of one or more conditional configurations, for example, by RRC signaling. At any given time, at least one of the conditional configurations may be active (e.g., or “serving”), and the remaining configurations may be stored but not active (e.g., “non-serving”). In certain scenarios, there may be a (e.g., at most one) conditional configuration in an “active” state, and such conditional configuration may be referred to as the “active configuration” (e.g., or “serving configuration”).

A conditional configuration may include a subset (e.g., all) of the RRC parameters that the WTRU uses to operate in connected mode. The WTRU may change the state of a (e.g., at least one) conditional configuration from “not active” to “active” (e.g., and vice-versa) if, for example, a certain condition or mobility trigger is met. For example, the conditions or mobility triggers may include one or more of the following. A WTRU may change the state of a conditional configuration from “not active” to “active” if the WTRU receives an indication from a MAC control element (e.g., or a DCI) that a first “active” configuration is to be changed to “not active” and a second “not active” configuration is to be changed to “active.” A WTRU may change the state of a conditional configuration from “not active” to “active” if the WTRU determines that a measurement event is triggered in the active configuration. For example, the measurement event may be linked to changing a first “active” configuration to “not active” and a second “not active” configuration to “active.” Also, or alternatively, if the first and second configurations have different PCells, the WTRU may change/update its PCell accordingly.

As described herein, when a WTRU performs such change of state for a (e.g., at least one) conditional configuration, the currently active conditional configuration may be referred to as the “source” configuration before the change, and the conditional configuration that is active after the change may be referred to as the “target” configuration. Similarly, the source and target PCell may refer to the PCell in respective source and target configurations. As described herein, the procedure for changing/updating the PCell may be referred to as a change of active configuration and/or a handover (HO) command.

A WTRU may receive additional configuration (e.g., transition configurations). Transition configurations may, for example, be specific to a change of active configuration from a first configuration to a second configuration. For example, a transition configuration may be defined using one or more of the following: the identity of the source configuration; the identity of the target configuration; and/or the identity of an additional configuration (e.g., which may be applicable when the WTRU changes the active configuration from the source to the target, for at least one additional configuration).

As described herein, the additional configuration may include one or more of the following: a measurement event, measurement object and/or measurement configuration; a type of procedure for transition (e.g. random access procedure or RACH-less procedure; one or more parameters or resources for performing the procedure (e.g. one or more dedicated preambles, pre-configured grants, scheduling request resources, etc.); and/or a (e.g., at least one) security parameter (e.g. KgNB).

A transition configuration may be realized by associated identities of source, target, and/or additional configurations. Also, or alternatively, each conditional configuration may include a (e.g., one) transition configuration for each possible source configuration if, for example, the conditional configuration is a target configuration. Also, or alternatively, each conditional configuration may include a (e.g., one) transition configuration for each possible target configuration if, for example, the conditional configuration is a source configuration.

A WTRU may be configured to synchronize to/with a new/updated PCell. One or more of the following may apply. For example, the WTRU may be configured to synchronize to/with a new/updated PCell if a change of active configuration results in a change of PCell. It should be noted that the techniques described herein may also, or alternatively, be used for changes/updates to the WTRU's PSCell.

A WTRU may update/change its PCell using a RACH-less procedure. One or more of the following may apply. For example, the WTRU may determine that a RACH-less procedure is applicable if the WTRU is initiating a change of active configuration. The RACH-less procedure may be initiated in response to receiving signaling (e.g., HO command) in a source PCell.

A WTRU may initiate the procedure following reception of signaling (e.g., such as a MAC CE or DCI indicating the change of active configuration, such as an HO command). Following reception of the MAC CE, the WTRU may initiate reception of PDCCH in the target PCell (e.g., using a configuration provided for the execution of the RACH-less procedure). For example, the WTRU may monitor the PDCCH in the target PCell in a search space and using a C-RNTI (e.g., a C-RNTI that is configured for a RACH-Less procedure).

The WTRU may initiate transmission of a MAC CE, for example, to indicate that the WTRU has executed the handover in the target configuration. The MAC CE may, for example, include: a WTRU identity (e.g., in the source and/or target cell); and/or a reference to the MAC CE that triggered the HO command. Such reference may consist of an identifier included in the HO command. For the transmission of the MAC CE, the WTRU may utilize a configured grant (CG) resource, which may be provided for the RACH-less procedure, or a dynamic grant received from the PDCCH. The WTRU may also initiate a scheduling request procedure using a scheduling request (SR) resource provided for the RACH-less procedure. The WTRU may further receive a MAC CE or DCI confirming completion of the handover. The WTRU may also, or alternatively, expect the MAC CE or DCI in certain situations (e.g., if the WTRU is provided with a configured grant for the transmission of the MAC CE that indicates handover execution). The WTRU may start a timer upon initial transmission of the PUSCH containing the MAC CE and stop the timer upon receiving the MAC CE or DCI. If the timer expires (e.g., or if a scheduling request failure occurs), the WTRU may determine that the handover has failed and perform actions accordingly.

The PDCCH, CG and/or SR resources provided for the RACH-less procedure may be valid for a period of time (e.g., a limited duration following initiation of the procedure). For example, the period of time may also, or alternatively, be configured as part of the RACH-less configuration.

A RACH-less procedure to update/change a WTRU's PCell may be initiated by a measurement event. One or more of the following may apply. The WTRU may initiate the RACH-less procedure when a measurement event is triggered. The WTRU may send a measurement report (e.g., by RRC or using a MAC CE) in the source PCell. The WTRU may then monitor (e.g., receive) the PDCCH in the target PCell, as described herein. The WTRU may continue to receive the PDCCH in the source PCell. The WTRU may initiate reception of PDCCH in the target PCell, for example, upon expiry of a timer. For example, that timer may be started when transmitting (e.g., or re-transmitting) a PUSCH that includes the MAC CE. The value of this timer may, for example, be pre-defined or configured by RRC. For example, the timer may be used to provide an opportunity for the network to request HARQ retransmissions of the PUSCH containing the MAC CE (e.g., if the initial transmission is not successfully detected).

A RACH-less procedure to update/change a WTRU's PCell may be initiated by an HO command and/or confirmation by the target cell. One or more of the following may apply. The WTRU may receive signaling, e.g., DCI or MAC CE in the target cell, that includes the HO command and/or confirmation of the HO. The WTRU may stop receiving/monitoring for a PDCCH in the source cell. The WTRU may also, or alternatively, initiate transmission of a MAC CE, which may be used to confirm completion of the procedure. The WTRU may start a timer (e.g., a supervisory timer), for example, upon initiating reception of PDCCH in the target PCell. The WTRU may stop the timer in response to receiving the DCI or MAC CE. If the timer expires, the WTRU may determine that the handover has failed and perform actions accordingly.

In certain scenarios a HO failure may occur. One or more of the following may apply. If the WTRU determines that the HO procedure has failed, the WTRU may interrupt reception of PDCCH in the target cell and resume reception of PDCCH in the source cell (e.g., if PDCCH monitoring in the source cell was stopped). The WTRU may initiate transmission of a MAC CE, which may be used to indicate the HO failure.

A WTRU may determine a type of transition procedure. One or more of the following may apply. The WTRU may determine (e.g., may first determine) a type of transition procedure to perform as part of the change of active configuration. A type of transition procedure may include one or more of the following: a random access procedure (e.g., 4-steps or 2-steps); and/or a RACH-less procedure (e.g., with or without make-before-break).

The WTRU may obtain resources for transition procedure. One or more of the following may apply. The WTRU may (e.g., after determining the type of transition procedure to perform) obtain resources and/or parameters associated with the type of transition procedure (e.g., random access or RACH-less resources). For example, the resources may include: a common RACH configuration (e.g. RACH-ConfigCommon or RACH-ConfigCommon TwoStepRA); a dedicated RACH configuration (e.g. RACH-ConfigDedicated); a PDCCH configuration of the target PCell (e.g., including search space(s)); a PUCCH and/or PUSCH configuration of the target PCell; an initial bandwidth part (BWP) of the target PCell; a configured grant configuration (e.g., for an initial transmission in a target PCell); a scheduling request (SR) resource for an initial transmission in a target PCell; an indication of a timing advance adjustment; an indication of whether to apply a timing advance of zero; and/or a (e.g., at least one) RNTI (e.g., C-RNTI).

A WTRU may determine the type of transition procedure and/or associated resources when changing the active configuration from source to target configuration as a function of the parameters included in respective configurations. One or more of the following may apply. For example, each configuration may include a “timing advance group” identity. The WTRU may perform a random access procedure if, for example, the timing advance group identities associated with the source and target configurations are different. The WTRU may perform a RACH-less procedure if, for example, the timing advance group identities of source and target are the same (e.g., or equal). If the timing advance group identities of the source and target are the same (e.g., or equal) the WTRU may not adjust the timing advance.

A WTRU may determine the type of transition procedure and/or associated resources based on the target configuration. One or more of the following may apply. For example, such target configuration may indicate an applicable common RACH configuration if, for example, the type of transition procedure is a random access procedure. For example, such target configuration may indicate that the type of transition procedure is a random access procedure for any change of active configuration with a given target configuration.

A WTRU may determine a type of transition procedure and/or associated resources based on the transition configuration received for the applicable combination of source and target configurations. For example, an applicable timing adjustment, a (e.g., at least one configured grant and/or an SR resource (e.g., in case of a RACH-less procedure) may be configured as part of the transition configuration for a given combination of source and target configurations.

A WTRU may determine to perform a random access transition procedure based on signaling (e.g., DCI or MAC CE). One or more of the following may apply. Such signaling may, for example, be the (e.g., be included in the) signaling that triggers the change of active configuration. For example, the WTRU may receive a MAC CE that indicates a change of active configuration. The MAC CE may include a field that indicates whether to perform random access. Also, or alternatively, the WTRU may determine whether to a perform random access transition procedure based on whether a certain field is present or not in the MAC CE. For example, the WTRU may determine to perform a random access transition procedure if (e.g., only if) a field that indicates a preamble (e.g., or whether to use a dedicated preamble) is present in the MAC CE.

The WTRU may determine a resource for the transition procedure based on signaling (e.g., MAC CE). The WTRU may receive an indication of a set of resources (e.g., configured by RRC) for the applicable target configuration or transition configuration. For example, RRC may be used to configure a set of one or more (e.g., 4) dedicated preambles (e.g., or configured grants, or SR resources) as part of a target configuration. If a change of active configuration occurs, the WTRU may receive an indication of the applicable dedicated preamble (e.g., or configured grant, or SR resources) by MAC CE, which may allow resource management facilitation for the network (e.g., since it brings the flexibility of dynamically assigning resources to each WTRU participating in L1/2 mobility).

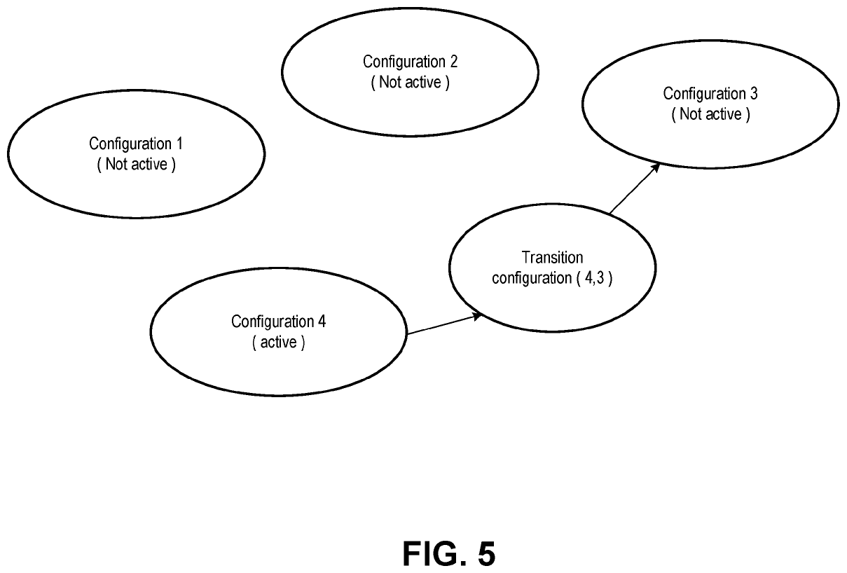

FIG. 5 illustrates example transition configurations. In this example the WTRU has been be provided with 4 configurations (e.g., corresponding to 4 cells) and a transition (e.g., temporary or intermediate) configuration to be applied when configuration 3 is to be applied after configuration 4 (e.g., when a handover is executed from cell 4 to cell 3).

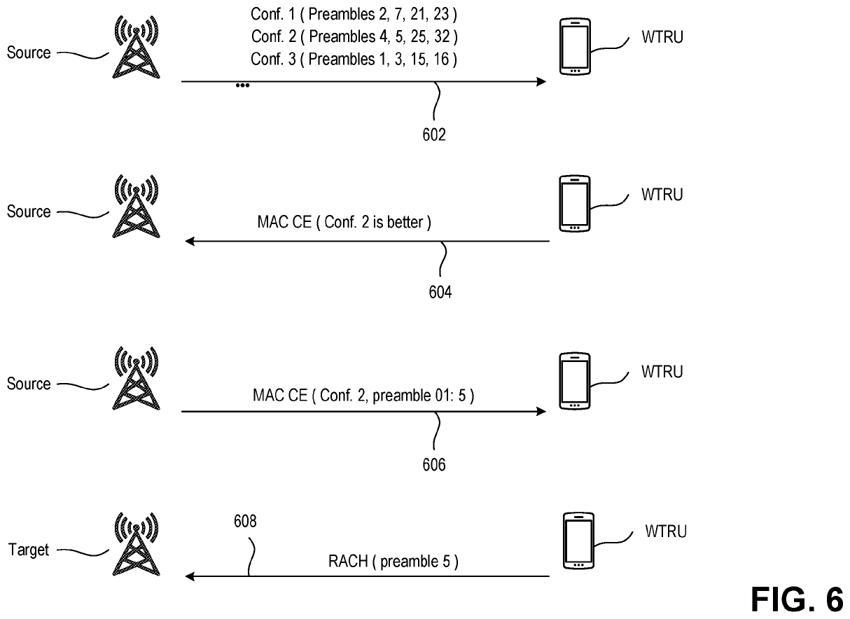

FIG. 6 illustrates example updating/changing a WTRU's PCell (e.g., or PSCell). At step 602, a WTRU may receive first signaling (e.g., via RRC) for at least one potential target cell, depicted as Cell 1, Cell 2, and Cell 3 in FIG. 6. The first signaling may be provided by a network node associated with the source cell. The first signaling may comprise a set of values for at least one resource and/or parameter applicable for transitioning to a target cell, such as, for example, a preamble for RACH (whether the procedure is a RACH-based procedure or a RACH-less procedure), an initial grant in the target cell, a C-RNTI, a timing advance, a beam indication, or the like, or any appropriate combination thereof. The first signaling may comprise a set of values associated with at least one resource and/or parameter applicable to the WTRU's transition from the current cell to the target cell. A set of values may be a single value or multiple values. A parameter may comprise a preamble for a RACH, an initial grant in a target cell, a RNTI, a parameter (or parameters) associated with a RACH-based procedure, a parameter (or parameters) associated with a RACH-less procedure, a timing advance, or the like, or any appropriate combination thereof. Although FIG. 6 depicts three configuration, Conf. 1, Conf. 2, and Conf. 3, each comprising RACH preamble parameters, the first signaling should not be limited thereto. Each configuration may comprise RACH-based parameters or RACH-less parameters. At step 604, the WTRU may provide an indication of one or more measurement associated with the source cell and the target cell. The WTRU may indicate (e.g., via a MAC CE for example) that a target cell has become better than the current (source) cell. The indication may be sent to a network node associated with the source cell. As depicted in FIG. 6, the WTRU indicates that Cell 2 is better than the current (source) cell. At step 606, the WTRU may receive second signaling (e.g., via a MAC CE for example). The second signaling may be received from a network node associated with the source cell. The second signaling may comprise an indication to switch to an indicated target cell. The second signaling may include an indication of a value (or values) to use associated with the switch. The value (or values) may be for a parameter (or parameters) from the at least one parameter provided in the first signaling. For example, as depicted in FIG. 6, the second signaling comprises an indication to switch Cell 2, and provides an indication to use specific parameters of configuration 2 that were provided in the first signaling. The example depiction in FIG. 6 the second signaling indicates the second parameter of configuration 2 (i.e., preamble 5) as provided in the first signaling. Specifically, as depicted, the second signaling comprises the indication 01:5. “01” is a binary value (e.g., from the values 00, 01, 10, 11) indicating which of the parameters to use. Thus “01” indicates the second parameter value, which is preamble 5. At step 608, the WTRU may switch to the targe cell using the indicated (or values) for the associated parameter (or parameters). The WTRU may provide an indication that the switch is occurring, or has occurred to the target cell. The indication may be provided to a network node associated with the target cell.

An HO command may be received from a target cell's PDCCH (e.g., make-before-break). One or more of the following may apply. For the support of L1/L2 inter-cell mobility, synchronization procedures towards/with the target cell may be improved. One or more of the following may apply. A WTRU may perform synchronization towards/with the candidate target cell, for example, before the HO procedure.

A WTRU may performs one or more of the following to support a make-before-break HO. The WTRU may determine the best quality cell(s) (e.g., based on neighboring cell measurements and/or serving cell measurements). The WTRU may report the best quality cell(s), for example, via uplink signaling (e.g. uplink MAC CE), which may be used to indicate the candidate target cells' information (e.g., PCI, CGI and/or frequency of the cell(s)). The WTRU may monitor for a PDCCH of the reported candidate target cell(s). The WTRU may wait for a PDCCH order associated with the HO command (e.g., or MAC CE indicating HO command) from gNB. The WTRU may receive a PDCCH order associated with an HO command from the candidate target cell. The PDCCH order associated with the HO command may be used to command/indicate to the WTRU to perform a HO from the current serving cell (e.g., SpCell) to the candidate target cell (e.g., where the WTRU may receive the PDCCH order associated with the HO command). Also, or alternatively, the WTRU may receive a MAC CE associated with the HO command, for example, from the current serving cell. The MAC CE associated with the HO command may be used to indicate the target cell information (e.g., where the WTRU performs HO from the current serving cell to the given target cell).

RLM may be performed at the candidate target cell, for example, with PDCCH monitoring. One or more of the following may apply. When the WTRU monitors the PDCCH of the reported candidate target cell(s) and waits for a PDCCH order associated with an HO command from gNB, the WTRU may perform RLM at the candidate target cell (e.g., as described herein) while the WTRU monitors PDCCH from the candidate target cell. If the WTRU declares RLF at the candidate target cell, the WTRU may stop monitoring for a PDCCH from the candidate target cell.

A PDCCH monitoring timer may be implemented, for example, to avoid the WTRU monitoring the PDCCH of the candidate target cell in perpetuity. A guard timer may be introduced. When the WTRU begins monitoring the PDCCH of the reported candidate target cell(s), the WTRU may start the guard timer. The WTRU may continue to monitor the PDCCH until the guard timer expires. The duration of the guard timer may be pre-defined and/or configured (e.g., by a configurable parameter given by RRC signaling). If the guard timer expires, the WTRU may discontinue the HO towards the candidate target cell, and may stop monitoring the PDCCH at the cell. An HO failure event may be reported to a gNB via uplink signaling (e.g. uplink MAC CE), which may indicate an HO failure event and/or may include the candidate target cell information.

PDCCH monitoring may be configured. One or more of the following may apply. While the WTRU begins monitoring the PDCCH of the reported candidate target cell(s), a gNB may configure (e.g., explicitly configure) the WTRU with a search space (SS) for the PDCCH order associated with HO command reception. The SS may be similar (e.g., the same as the candidate target cell's SS in CORESET#0 and/or may be separately configured (e.g., so that WTRU may monitor a limited/targeted search space). The PDCCH monitoring configuration for the PDCCH order associated with the HO command may further indicate whether the WTRU is to monitor (e.g., only) the candidate target cell's PDCCH or whether WTRU is to monitor the PDCCH from the current serving cell and/or the PDCCH from the candidate target cell. The WTRU may indicate whether the WTRU is able to monitor both serving cell's PDCCH and the candidate target cell's PDCCH simultaneously and/or the WTRU is able to monitor either the serving cell's PDCCH or the candidate target cell's PDCCH.

Link management may be performed. For example, radio link monitoring (RLM) may be performed at a candidate target cell. One or more of the following may apply. A WTRU may determine whether the WTRU has suitable radio conditions at the candidate target cell prior to the HO procedure (e.g., to reduce the probability of HO failure). The WTRU may perform RLM at the candidate target cell(s) prior to the HO procedure, for example, while the WTRU monitors for a PDCCH from the candidate target cell. A gNB may provide the WTRU the a RLM configuration (e.g., an IE “RadioLinkMonitoringRS”) for each candidate target cell(s), for example, so that the WTRU may be able to perform the RLM at one or more of the candidate targets cells. For example, the RLM configuration may be provided as part of measurement configuration.

If, for example, a WTRU continuously performs RLM at the candidate target cell(s), the WTRU may drain its battery. Candidate cell RLM may be performed for a limited time duration (e.g., to conserve the WTRU's battery).

A WTRU's battery may be conserved. One or more of the following may apply. The WTRU may initiate an RLM at a candidate target cell if (e.g., only if) certain conditions are met. For example, the conditions for performing RLM may include: the radio conditions of the current serving cell (e.g. SpCell) are below certain threshold (e.g., RSRP and/or RSRQ are/is below thresholds/a threshold); the candidate target cell's radio conditions are above a threshold (e.g. RSRP and/or RSRQ of the candidate target cell are/is above thresholds/a threshold); and/or the radio conditions of the candidate target cell is determined to be better than the radio conditions of the current serving cell (e.g. SpCell). The WTRU may consider these conditions to be met if (e.g., only if) said conditions are met for a certain amount of time. For example, the amount of time may be pre-defined and/or configured. The WTRU may initiate/indicate an RLF if one or more of the conditions are met. The WTRU may report the candidate target cells that met the conditions, for example, by uplink signaling.

A WTRU's battery may be conserved, for example, using an RLM candidate cell report. One or more of the following may apply. A WTRU may report the candidate target cell(s), for example, by uplink signaling (e.g. uplink MAC CE) if certain conditions are met (e.g., as described herein).

A WTRU's battery may be conserved, for example, via an RLM command. One or more of the following may apply. A gNB may send a command to the WTRU that indicates that the WTRU is to perform an RLM at a particular candidate target cell. For example, the command may be delivered via downlink MAC CE and may include the RLM command indication and the candidate target cell for which to perform RLM. The gNB may determine the content of the RLM command, for example, according to the generated report generated (e.g., as described herein).

Radio Link Failure (RLF) may be declared (e.g., by a WTRU) at the candidate target cell. One or more of the following may apply. A WTRU may declare in-sync and/or out-of-sync, for example, while the WTRU performs the RLM at the candidate target cell. If the WTRU detects a number of consecutive out-of-sync indications, the WTRU may declare a radio link failure (RLF) at the candidate target cell and may determine that the candidate target cell is no longer a candidate as the next SpCell. RLF declaration may be delayed, for example, by a timer (e.g., after a detection of a number of consecutive out-of-sync indications). If the WTRU detects a number of consecutive in-sync indications while the timer is running, the WTRU may determine that the physical layer problem has been addressed and stop the timer (e.g., the WTRU no longer declares that an RLF has occurred). The number of consecutive out-of-sync indications, the number of consecutive in-sync indications, and/or the timer may be pre-defined and/or configured, for example, by RRC signaling (e.g., as part of RLM configuration for the candidate target cell).

If a WTRU declares an RLF at a candidate target cell, the WTRU may no longer perform RLM at the candidate target cell. The WTRU may report the RLF event to a gNB, for example, by uplink signaling (e.g. uplink MAC CE). For example, the uplink signaling may include the information associated with the candidate target cell for which an RLF was declared. Similarly, the WTRU may perform beam management at the candidate target cell and/or may determine whether to continue HO attempts towards the candidate target cell (e.g., based on the beam management status).

What is claimed is:

1-20. (canceled)

21. A method performed by a wireless transmit/receive unit (WTRU), the method comprising:
receiving a plurality of transmission configuration indicator (TCI) states associated with a respective plurality of non-serving cells;
receiving medium access control (MAC) control element (CE) signaling comprising an indication to active one of the plurality of TCI states;
activating the one TCI state; and
transitioning to a non-serving cell associated with the one TCI state.

22. The method of claim 21, further comprising receiving the plurality of TCI states via radio resource control (RRC) signaling.

23. The method of claim 21, wherein each of the plurality of TCI states is associated with a physical downlink control channel (PDCCH).

24. The method of claim 21, wherein each of the plurality of TCI states is associated with a physical downlink shared channel (PDSCH).

25. The method of claim 21, wherein each of the plurality of TCI states is associated with a reference signal (RS) for selecting a beam of a non-serving cell.

26. The method of claim 21, wherein each of the plurality of TCI states is associated with a synchronization signal and physical broadcast control channel block (SSB) for selecting a beam of a non-serving cell.

27. The method of claim 26, wherein the SSB is associated with physical cell ID (PCI) of a non-serving cell.

28. The method of claim 21, further comprising receiving an indication to activate a subset of the plurality of TCI states.

29. The method of claim 28, the indication to activate a subset of the plurality of TCI states is received via downlink control information (DCI) signaling.

30. A wireless transmit/receive unit (WTRU) comprising:
a transceiver; and
a processor configured to:
receive, via the transceiver, a plurality of transmission configuration indicator (TCI) states associated with a respective plurality of non-serving cells;
receive, via the transceiver, medium access control (MAC) control element (CE) signaling comprising an indication to active one of the plurality of TCI states;
activate the one TCI state; and
transition to a non-serving cell associated with the one TCI state.

31. The WTRU of claim 30, further comprising receiving the plurality of TCI states via radio resource control (RRC) signaling.

32. The WTRU of claim 30, wherein each of the plurality of TCI states is associated with a physical downlink control channel (PDCCH).

33. The WTRU of claim 30, wherein each of the plurality of TCI states is associated with a physical downlink shared channel (PDSCH).

34. The WTRU of claim 30, wherein each of the plurality of TCI states is associated with a reference signal (RS) for selecting a beam of a non-serving cell.

35. The WTRU of claim 30, wherein each of the plurality of TCI states is associated with a synchronization signal and physical broadcast control channel block (SSB) for selecting a beam of a non-serving cell.

36. The WTRU of claim 35, wherein the SSB is associated with physical cell ID (PCI) of a non-serving cell.

37. The WTRU of claim 30, further comprising receiving an indication to activate a subset of the plurality of TCI states.

38. The WTRU of claim 37, the indication to activate a subset of the plurality of TCI states is received via downlink control information (DCI) signaling.

39. The WTRU of claim 30, wherein WTRU is configured with the plurality of TCI states.
